(19) United States
(12) Patent Application Publication
(10) Pub. No.: US 2014/0081476 A1
(43) Pub. Date: Mar. 20, 2014

(54) METHOD FOR ASSISTING A DRIVER OF A MOTOR VEHICLE

(71) Applicants: Lidia-Pilar Verdugo-Lara, Stuttgart (DE); Jerome Rigobert, Stuttgart (DE); Marcus Schneider, Ludwigsburg (DE); Volker Niemz, Rutesheim (DE); Inga Schierle, Leonberg (DE); Raphael Cano, Stuttgart (DE); Akos Merkel, Budapest (HU)

(72) Inventors: Lidia-Pilar Verdugo-Lara, Stuttgart (DE); Jerome Rigobert, Stuttgart (DE); Marcus Schneider, Ludwigsburg (DE); Volker Niemz, Rutesheim (DE); Inga Schierle, Leonberg (DE); Raphael Cano, Stuttgart (DE); Akos Merkel, Budapest (HU)

(21) Appl. No.: 13/984,448

(22) PCT Filed: Jan. 31, 2012
(86) PCT No.: PCT/EP2012/051496

§ 371 Date: Nov. 26, 2013

(30) Foreign Application Priority Data
Feb. 9, 2011 (DE) 10 2011 003 881.7

(51) Int. Cl. B62D 15/02

(52) U.S. Cl. CPC B62D 15/027
USPC 701/1

(57) ABSTRACT

A method is described for assisting a driver of a motor vehicle in which the surroundings laterally next to the motor vehicle, in order to detect a parking space. When a parking space is detected, a trajectory is determined, along which the motor vehicle is able to park in the parking space. During the parking, the surroundings of the motor vehicle are monitored.

Upon detection of a specified situation, the parking space readout is stopped for a specified distance, the parking process is aborted or a warning is issued to the driver. Also described is a device for implementing the method.

### Field of the Invention

The present invention relates to a method for assisting the driver of a motor vehicle during a parking process . The present invention also relates to a device for assisting a driver of a motor vehicle during a driving maneuver.

### BACKGROUND INFORMATION

So-called driver assistance systems are used for carrying out methods for assisting a driver of a motor vehicle in driving maneuvers. At present, parking assistance systems which support the driver during parking are particularly normal. Parking assistance systems are distinguished into those which detect the surroundings of the vehicle and warn the driver when an object approaches and those which first detect whether a suitable parking space is available and then calculate a trajectory along which the vehicle is able to be parked in the parking space. In order to park the vehicle, the driver is then either given information on how to steer the vehicle in order to move it along the trajectory, or the steering movements are automatically carried out by the vehicle. Furthermore, it is also possible for the vehicle to be parked in the parking space fully automatically along the trajectory, and for the driver to have only a supervising function.

In parking assistance systems, the surroundings on both sides, left and right next to the vehicle, are usually first recorded in passing, in order to find a suitable parking space. In this context, the recording of the surroundings takes place as soon as the vehicle is moving, and has not exceeded a specified speed threshold. Alternatively, it is also possible that the recording takes place according to functional selection, for instance, by operating a function button.

What is disadvantageous in systems for recording the surroundings is, however, that, for example, situations are wrongly detected as being parking spaces if, for instance, an unintended activation of the parking space search has taken place. Such false measurements may come about, for example, if the motor vehicle is being passed by two vehicles traveling at the distance of a parking space. The image detected by the sensors is equal, in this context, to the image of a parking space, and a suitable parking space is indicated to the driver. Besides due to passing vehicles, the same may also happen in response to oncoming vehicles. Moreover, it is possible that, for instance, the boundaries of a traffic island, such as at pedestrian crossings, are identified as parking spaces. Because of the small width of perpendicular parking spaces, the probability of a misinterpretation is greater in this case than in longitudinal parking spaces.

In the case of perpendicular parking spaces, the additional problem comes up that parking space boundaries are not always recognized correctly. Thus, it is possible, for example, that the region between two post-like objects is recognized as a perpendicular parking space. In this case, for example, bollards on a mole may be involved. If the driver does not recognize the error, this may lead to an erroneous parking, and, for example, in the case of a mole, it may lead to a serious accident, such as a sudden plunge into the water.

A method and a device for supporting a parking process are known from DE-A 10 2005 044 270, for example. In the method described in this instance, boundary object types are assigned to the boundaries of a parking space. Such types are, for instance, motor vehicles, curbs, motorcycles, persons, round objects, plants or the like.

A method and a device for detecting parking spaces during the passing of a vehicle by such a space are also described in German Published Patent Appln. No. 10 2006 005 059.

In each of the known systems it is only detected whether a gap is big enough as a parking space. An investigation as to whether a parking space is actually involved does not take place.

### SUMMARY

In the method according to the present invention, for assisting the driver of a motor vehicle, the surroundings at the side next to the motor vehicle are recorded in order to detect a parking space. When a parking space has been detected, a trajectory is determined along which the motor vehicle is able to park in the parking space, the surroundings of the motor vehicle being monitored during parking. Upon detection of a specified situation, the parking space readout is stopped for a specified distance, the parking process is aborted or a warning is issued to the driver.

Owing to the method according to the present invention, there comes about an additional improvement of parking systems, since because of the stopping of the parking space readout for a specified distance, upon detection of a specified situation, only actually present parking spaces are read out, and because of the aborting the parking process and the output of the warning to the driver, it is additionally avoided that the vehicle moves unobserved into a dangerous situation.

Upon detection of a specified situation, if the readout of a parking space is stopped for a specified distance, the risk of a malfunction is lowered. Because of the method, it is avoided that areas are detected as parking spaces which actually are not. By avoiding the false detection of parking spaces, the safety of the system is increased, since even one of the first paths of error, namely, the path “successfully detected parking space”, is prevented. For, depending on the setting of the driver assistance system, it is possible that the steering already becomes active as soon as the reverse gear is put in.

The detection of a parking space is only possible when the vehicle measuring the parking space is moving. Based on the vehicle's motion, the distance covered is able to be determined using the wheel pulse counters. This distance may be balanced with the data received from distance sensors that are used for the detection. As soon as a space corresponds to the stored rules and a minimum length, the system is notified that a parking space has been detected.

Since, however, only the distance covered and the image recorded by the distance sensors are drawn upon for judging a parking space, it is possible, for example, that a parking space may also be detected if the vehicle is being passed by two vehicles traveling at the distance apart of a parking space or, alternatively, they are oncoming at a corresponding distance apart. In this case, a parking space is read out as well. Furthermore, it is also possible that, at a traffic signal, for example, that is marked by guide poles, a parking space is detected.

One specified situation, in which the parking space readout for a specified distance is stopped, is for instance the detection of passing or oncoming vehicles, or the detection of a pedestrian crossing or a multi-lane road. The specified distance for which the parking space readout is stopped, is the length of a minimum parking space, for example.

Aborting of the parking process or the output of a warning to the driver takes place, for example, if a limiting by poles is detected in the case of a perpendicular parking space. The limiting by poles may be on one side or on both sides, in this context. Since poles are supposed to be used in areas in which there is no parking, for instance, because there is possible danger, such as a river bank or a mole, it is advantageous in such a situation either to abort the parking process or at least to warn the driver. In the case of a warning, the driver is automatically able to decide whether there is a parking space, and whether the parking process is to be continued.

An object is, for instance, detected as being a pole if first a decrease in the distance to an object is measured and subsequently an increase of the distance to the object is measured. This yields a characterizing image that is able to be interpreted as a pole.

For the detection of a parking space during the passing by and the monitoring during the parking process, to detect, for example, whether objects are located on the planned path into the parking space or, for example, whether the limiting by a pole was detected, distance sensors are normally used. Suitable sensors are, for instance, ultrasonic sensors, infrared sensors, radar sensors, LIDAR sensors or optical sensors, such as cameras. The use of ultrasonic sensors is customary and is preferred.

In order to output a parking space only if the detected parking space actually is a parking space, it is necessary, for example, to detect passing or oncoming vehicles. For this purpose, radar sensors or optical sensors may be used. When radar systems are used, passing or oncoming vehicles may be detected based on the emitted radar beams, for example. The Doppler effect may be utilized for this.

Even when using ultrasonic sensors one is able to use the Doppler effect to detect passing or approaching vehicles. When ultrasound sensors are used, those ultrasound sensors are particularly suitable which are used as parking space searching sensors, and are usually located in the front region of the vehicle. The parking space searching sensors usually record the region laterally next to the vehicle. Besides the parking space searching sensors, one may also, or in addition use so-called “blind spot sensors”, by which the blind spot of the vehicle is able to be monitored. The blind spot sensors are usually located in the rear section of the vehicle, and they record the region that is slantwise behind the vehicle.

For the evaluation of the Doppler effect, the analog signal received is usually used directly.

Passing and oncoming vehicles may also be recognized using an optical sensor, such as a camera. In this instance, one is able to detect the motion of the vehicle, for example, by the change in the position of the vehicle with respect to a characteristic fixed point, such as a roadway marking. By using optical sensors, it is also possible to detect roadway markings such as pedestrian crossings having zebra stripes. Within the scope of an optical traffic sign detection, it is also possible to detect pedestrian crossings having an appropriate signage or by traffic lights.

In order to avoid a parking space being detected on a multi-lane road, it is possible, for example, to use the data of a navigation system, in which it is stored that the currently traveled road is a multi-lane road. Thus, parking spaces should only be output if the vehicle is located in the lane at the edge stripe, and not at the middle stripe of the roadway. A parking space is also only located at the edge of the road and not at the middle. Parking spaces are read out because of the detection of parking spaces only in the edge region and the simultaneous detection that the vehicle is moving in the lane at the edge of the roadway. If the vehicle were moving in a middle lane or if passing or oncoming vehicles are detected, no parking space is read out. Furthermore, no parking spaces are read out if the vehicle is moving on a federal highway or an expressway.

The detection of oncoming or preceding vehicles may also take place by using a high-beam assistant. Oncoming or preceding vehicles may be detected by the high-beam assistant.

One additional possibility for detecting passing vehicles is a blind spot assistant. In this instance, a sensor is used to record particularly the region behind and next to the vehicle. The monitoring in this case also usually takes place based on ultrasound. As soon as the rear sensor detects a vehicle, and with that, a situation in which the driver has pointed out to him an object at the blind spot, a parking space readout may also be interrupted, since, in response to detecting a blind spot situation, the probability of a multi-lane road is very high.

A device for carrying out the method includes an arrangement for recording the surroundings laterally next to the motor vehicle, an arrangement for determining a trajectory along which the vehicle is able to park in a detected parking space, as well as an arrangement by which, upon the detection of a specified situation, the reading out of a parking space is able to be stopped for a specifiable distance, the parking procedure is able to be aborted or a warning is able to be output to the driver.

The arrangement for determining the trajectory and the arrangement by which, upon the detection of a specified situation, the parking space readout is able to be stopped for a specified distance, or a warning is able to be output to the driver, include, for example, a control unit having a storage medium and a microprocessor. On the storage medium, program code may be stored which controls the analysis. In addition, on the storage medium typical data may be stored for situations in which stopping the parking space readout, the aborting of the parking process or the output of a warning to the driver are supposed to take place. As was mentioned above, the specified situations are, for example, the detection of oncoming or passing vehicles, the detection of a pedestrian crossing or a multi-lane road, as well as the detection of parking space limiting poles.

An arrangement for recording the surroundings laterally next to the motor vehicle are ultrasonic sensors, infrared sensors, radar sensors, LIDAR sensors and optical sensors such as cameras, for example. Ultrasonic sensors are particularly preferred.

### BRIEF DESCRIPTION OF THE DRAWINGS

FIG. 1 shows a detection of a perpendicular parking space.

FIG. 2 shows a detection of a longitudinal parking space.

FIG. 3 shows a parking space detection in response to passing vehicles.

FIG. 4 shows a parking space detection in response to the appearance of a pedestrian crossing.

FIG. 5 shows a parking process in a perpendicular parking space bordered by vehicles.

FIG. 6 shows a detected object distance in the situation shown in FIG. 5.

FIG. 7 shows a parking process in a parking space bordered by poles.

FIG. 8 shows a detected distance from the poles bordering the parking space.

### DETAILED DESCRIPTION

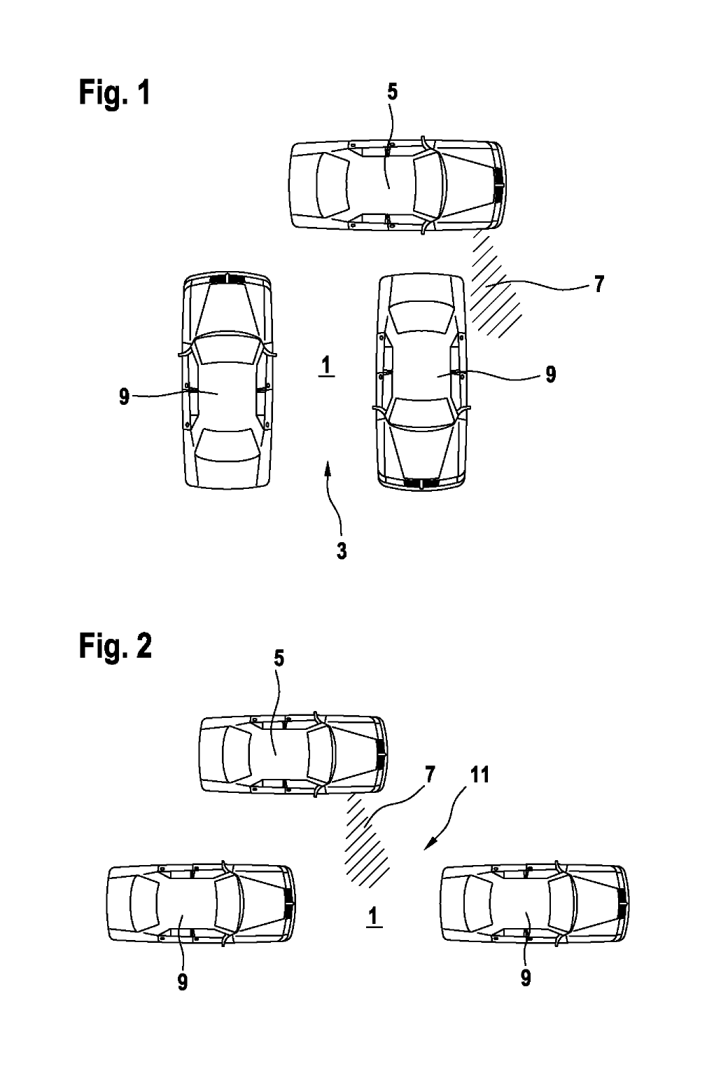

FIG. 1 shows the detection of a perpendicular parking space while passing using a vehicle. In order to identify a space 1 as a parking space 3, while passing using a motor vehicle 5, the surroundings of motor vehicle 5 are recorded laterally next to motor vehicle 5. For the detection, distance sensors, such as ultrasonic sensors are usually used. In FIG. 1 this is shown by a sonic lobe 7 for an ultrasonic sensor. Using the distance sensor, the distance from objects in the recording range, i.e. in the range covered by sonic lobe 7, is detected. In the regions in which no object is detected, a space 1 is assumed. This may be bordered by vehicles 9, for example, as shown in FIG. 1.

If the distance between vehicles 9 is wide enough, the conclusion is that it is a parking space. In the case of a perpendicular parking space, the width between vehicles 9 has to be a little greater than the width of the measuring vehicle 5, so that after the parking of vehicle 5 in space 1 identified as perpendicular parking space 3, sufficient space remains on both sides of vehicle 5 so that the doors of vehicle 5 may still be opened.

As soon as the driver assistance system has found a space 1 suitable as a perpendicular parking space 3, this is reported to the driver. The driver now has to activate the parking system and is guided into perpendicular parking space 3. In this connection, it is possible, on the one hand, that necessary steering motions are indicated to the driver, or alternatively the vehicle is steered automatically. In this case, the longitudinal guidance, i.e. accelerations, speed, stopping and braking remain with the driver. Furthermore, it is also possible that the parking process is carried out fully automatically, and that the system takes over the longitudinal as well as the perpendicular guidance.

The detection of a longitudinal parking space is shown in FIG. 2. The detection procedure essentially corresponds to that shown in FIG. 1. By contrast to a perpendicular parking space as shown in FIG. 1, a longitudinal parking space is longer, however, the length being selected so that the vehicle is preferably able to be parked in parking space 3 in one move. It is possible, however, that the minimum parking space length is selected so that the vehicle is able to be parked requiring more than one move, using three moves, for example. Preferably, however, a space 1 is only read out as a longitudinal parking space 11 if the parking process is able to be carried out in one move.

Perpendicular parking space 3 and longitudinal parking space 11 may, for instance, be bordered by vehicles 9, as shown in FIGS. 1 and 2. Moreover, it is also possible that the bordering of parking spaces 3, 11 are formed, for example, by a vehicle and another object, such as a bollard, a wall or a plant. The bordering by two objects different from vehicles is also possible, for instance, walls, plants, bollards, curbs or similar borderings. The borderings may be the same or different, in this connection.

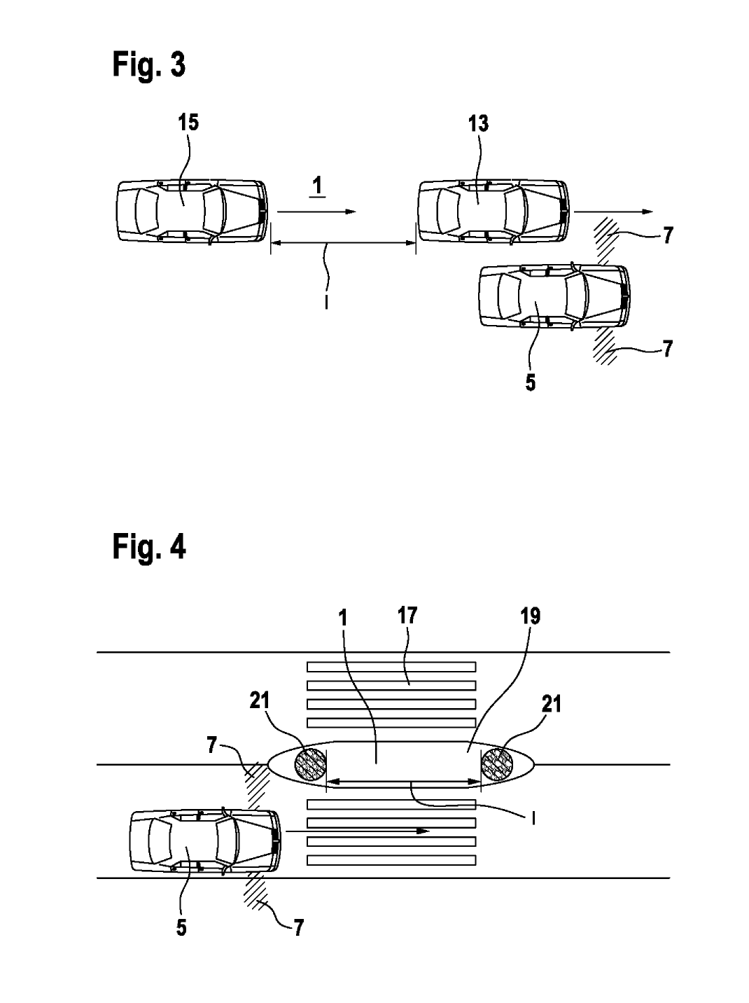

The danger, in particular if the parking space is bordered by two vehicles, as shown in FIG. 2, is that a space 1 between two traveling vehicles is interpreted as a parking space, for example. One situation in which this is able to occur is shown in FIG. 3, in exemplary fashion.

Vehicle 5, looking for the parking space, is traveling using activated distance sensors to record the surroundings. The detection is shown in this case by sonic lobes 7, in exemplary fashion. In the present case, vehicle 5 is being passed by a first vehicle 13 and a second vehicle 15 following the first vehicle. There is a space 1 located between vehicles 13, 15, whose length 1 corresponds to at least the minimum parking space length. An image is therefore recorded by the distance sensor of vehicle 5, which corresponds to that of a parking space. Space 1 between first vehicle 13 and second vehicle 15 is therefore erroneously detected as a parking space and read out as such.

The same situation as the one shown in FIG. 3 comes about not only during the passing by vehicles whose distance from each other corresponds to the minimum parking space length, but also in the case of oncoming vehicles being at the corresponding distance apart. In this case, a parking space is detected by the driver assistance system in each case on the side on which the vehicles are passing or on the side on which the oncoming vehicles are driving by.

According to the present invention, in order to avoid such an erroneous reading out, in addition to the distance between the objects, in this case vehicles 13, 15 and the route covered by measuring vehicle 5, it is also detected whether the objects, that have been detected, are moving. For this purpose, it is possible, for example, to use radar sensors or optical sensors by which the motions of a vehicle are able to be recorded.

The probability that the objects recorded by the system are moving vehicles is also very great if vehicle 5, seeking a parking space, is moving on a multi-lane road. If it is known that the road is a multi-lane road, it is, for example, possible right from the start to exclude looking for a parking space on the driver's side of vehicle 5. Furthermore, a parking space may also be excluded if the vehicle is moving, for example, in the middle or left lane of a multi-lane roadway. For, a potential parking space would only be found next to the right lane. In traffic systems having left-hand traffic, in a corresponding manner, a parking space would only be found if the vehicle is moving in the left lane.

The determination as to whether the road is a multi-lane road, is able to be made by the support of a navigation system in which the lane features are stored. Data on the properties of the road on which vehicle 5, seeking the parking space, is located, from the navigation system, are supplied to the driver assistance system which assists the driver in parking. In addition, for instance, by using an optical sensor, such as a camera, it may be ascertained in which lane the vehicle is moving. If it is detected by the optical sensor system that the vehicle is being driven in the middle or left lane, the readout of a parking space is stopped.

Furthermore, no parking spaces should be read out if the vehicle is moving on a federal highway or an expressway. It may further be detected from the data of a navigation system whether the vehicle is located in the area of a road crossing. In this case, the readout of a parking space should also be omitted.

Besides an erroneous detection of a parking space, which comes about due to the distance apart of two passing or oncoming vehicles, a parking space may also be erroneously detected in the area of a passenger crossing 17.

If pedestrian crosswalk 17 has a traffic island 19, whose beginning and end are marked by bollard 21, for example, space 1 between bollards 21 may be identified as a parking space if distance 1 between bollards 21 corresponds to the minimum length for a longitudinal parking space or the minimum distance apart for a perpendicular parking space. In order to exclude that space 1 between bollards 21 is identified as a parking space, it is possible, for example, additionally to monitor, using optical systems, whether in the area of space 1 there exists a pedestrian crosswalk, which may be identified as a zebra stripe, for example. Traffic sign monitoring may also be used, for instance, and in the case in which a traffic sign identifying a pedestrian crosswalk is detected, parking space readouts are excluded. In this way, it is avoided that a parking space is erroneously read out.

Besides the recording of traffic signs for ascertaining whether there is a pedestrian crosswalk in the area of space 1, a traffic light detection may also take place. Since there is to be no parking in the area of a traffic light, the readout of a parking space may also be stopped when a traffic light system is detected. This is also possible when a space 1 is detected on the side pointing to the edge of the roadway. As soon as the minimum distance from a detected traffic light or detected pedestrian crosswalk 17 is recorded, the readout of a parking space is stopped until vehicle 5, which is looking for the parking space, has passed the area of the traffic light or of the pedestrian crosswalk. Consequently, spaces 1, which are in areas in which there is to be no parking, are not offered to the driver as a parking space in the first place.

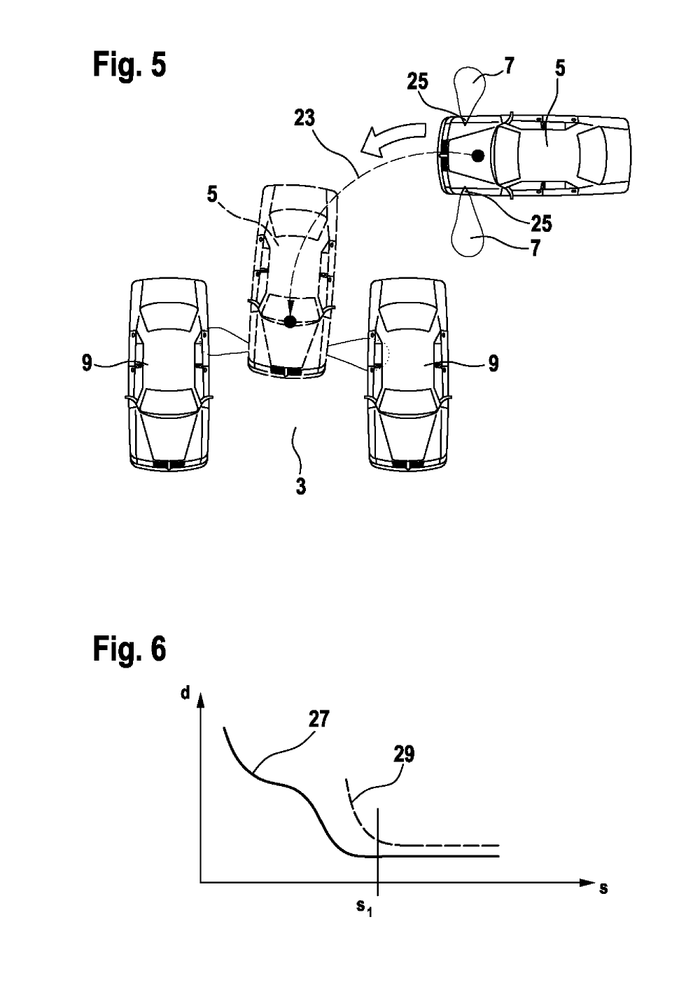

When a regulation parking space has been detected, a trajectory 23 into the parking space is calculated. The process along trajectory 23 into parking space 3 is shown in FIG. 5 for a perpendicular parking space 3, in exemplary fashion.

During the parking process, as long as vehicle 5 is moving along trajectory 23, the surroundings of the vehicle are further recorded using suitable distance sensors. The recording of the surroundings is shown in this case, too, by sonic lobes on the vehicle. During the parking process, the distance from objects laterally beside the vehicle is recorded. At first, no object is located within the recording range of sensors 25, so that the distance from an object recorded by the sensors is a maximum. During the parking process, vehicles 9 which border on parking space 3 each come into recording range of sensors 25. During the parking process, first of all vehicle 9 bordering the right side of parking space 3 and then vehicle 9 bordering the left side of parking space 3. As soon as vehicle 5, which is parking in parking space 3, moves in parallel to vehicles 9 that border parking space 3, the distance from an object detected by sensors 25 remains essentially constant. The distance from an object recorded by sensors 25 is shown exemplarily in FIG. 6. The distance from an object that is detected is shown on the y axis and the path covered by vehicle 5 is shown on the x axis.

S₁ marks the point at which the parking of vehicles 5 detects both the objects bordering on parking space 3.

The distance from an object recorded by the right sensor of motor vehicle 25 is shown by a solid line 27, and that recorded by the left sensor is shown by a dashed line 29.

As soon as vehicle 5 moves in parallel to vehicles 9 bordering perpendicular parking space 3, the distance recorded by sensors 25 on the left side and on the right side remains essentially constant. Because of the distances remaining the same during driving, it is assumed that the objects bordering on parking space 3 are vehicles 9. Thereby the system recognizes that this is a proper parking space.

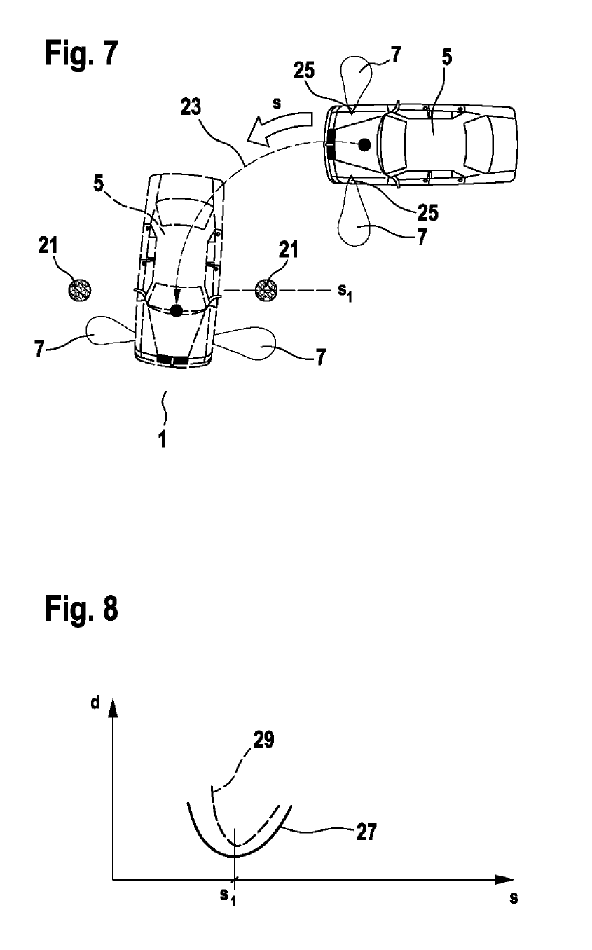

FIG. 7 shows a parking process in a space 1, space 1 being bordered by bollards 21. While driving by, one first of all assumes a proper parking space. After detection of space 1 as a parking space, the parking process begins. During parking, here too, the surroundings are recorded further by distance sensors 25 in the rear section of vehicle 5. The distance from objects 21 bordering on the parking space, which is recorded by sensors 25, is shown in FIG. 8. During the parking process, the distance from objects 21 first decreases. Based on the lacking length extension of objects 21, which are, for instance, embodied as bollards having a circular cross section, the distance recorded by the sensors increases again after bollards 21 are passed, at a point sᵢ, until bollards 21 have left the recording range of sensors 25 shown by sonic lobes 7. In FIG. 8, the distance from bollard 21 recorded by the right sensor is also shown by a solid line 27 and that recorded by the left sensor by a dashed line 29.

Because of the increase of the distance from the objects bordered by space 1 after the reaching of a minimum distance, one may conclude that the objects bordering space 1 are no vehicles 9, and that there consequently exists the possibility that space 1, in which vehicle 5 is parking, is not a proper parking space. Based on the curve of the distance recorded by sensors 25, it is assumed that space 1 is not a valid parking space and the parking process may be aborted. Alternatively it is also possible that the parking assistance system output a warning to the driver. The output of a warning is preferred. After the output of the warning to the driver, he is able to decide whether he wants to continue the parking maneuver, because this may, after all, possibly be a regular parking space, which has been bordered by posts, or the driver may still abort the parking maneuver, since no proper parking space is involved.

The warning to the driver may be output optically, acoustically or haptically, for example. An optical warning may be made, for example, by an appropriate warning signal within the range of view of the driver, such as a warning lamp lighting up. It is also possible to provide a text message over the onboard computer, for example, which depicts the situation in a few words.

An acoustical warning may take place by the output of a warning signal or by a voice message. A haptic warning of the driver may be implemented by a changed pedal pressure, a vibration or the like. In warning the driver, an acoustical or an optical signal, or a combination of the two is preferred.

1.-11. (canceled)

12. A method for assisting a driver of a motor vehicle, comprising:
recording surroundings laterally next to the motor vehicle, in order to detect a parking space;
when the parking space has been detected, determining a trajectory along which the motor vehicle is able to be parked in the parking space;
monitoring the surroundings of the motor vehicle during a parking of the motor vehicle; and
upon detection of a specified situation, one of:
stopping a parking space readout for a specified distance, aborting the parking, and issuing a warning to the driver.

13. The method as recited in claim 12, wherein the stopping of the parking space readout takes place when one of:
one of a passing vehicle and an oncoming vehicle is detected,
a pedestrian crosswalk is detected, and
a multi-lane road is recognized.

14. The method as recited in claim 12, wherein one of the parking process is aborted and the warning is output to the driver if a bordering by a post is detected in the case of a perpendicular parking space.

15. The method as recited in claim 14, wherein an object is detected as being the post if a decrease in a distance from the object and a subsequent increase in the distance from the object are measured.

16. The method as recited in claim 13, wherein one of a radar sensor and an optical sensor is used to detect the one of the passing vehicle and the oncoming vehicle.

17. The method as recited in claim 13, wherein data of a navigation system are used to detect the multi-lane road.

18. The method as recited in claim 13, wherein a high-beam assistant is used to detect the one of the passing vehicle and the oncoming vehicle.

19. The method as recited in claim 13, wherein a blind spot assistant is used to detect the passing vehicle.

20. A device for assisting a driver of a motor vehicle during a driving maneuver, comprising:
an arrangement for recording surroundings laterally next to the motor vehicle, in order to detect a parking space;
an arrangement for, when the parking space has been detected, determining a trajectory along which the motor vehicle is able to be parked in the parking space;
an arrangement for monitoring the surroundings of the motor vehicle during a parking of the motor vehicle; and
an arrangement for, upon detection of a specified situation, one of:
stopping a parking space readout for a specified distance,
aborting the parking, and
issuing a warning to the driver.

21. The device as recited in claim 20, wherein the arrangement for determining the trajectory and the arrangement by which, upon the detection of the specified situation, one of the parking space readout is able to be stopped for the specified distance, the parking process is able to be aborted, and the a warning is able to be output to the driver, include a control unit having a storage medium and a microprocessor.

22. The device as recited in claim 20, wherein the arrangement for recording the surroundings laterally next to the motor vehicle includes at least one of an ultrasonic sensor, an infrared sensor, a radar sensor, a LIDAR sensor, and an optical sensor.
